(19) United States
(12) Patent Application Publication
(10) Pub. No.: US 2025/0162259 A1
(43) Pub. Date: May 22, 2025

(54) THREE DIMENSIONAL SHAPING DEVICE

(71) Applicant: SEIKO EPSON CORPORATION, Tokyo (JP)

(72) Inventors: Yugo ISHIKAWA, SHIOJIRI-SHI (JP); Masayuki GOZU, INA-SHI (JP)

(21) Appl. No.: 18/955,276

(22) Filed: Nov. 21, 2024

(30) Foreign Application Priority Data
Nov. 22, 2023 (JP) 2023-198343

(51) Int. Cl. B29C 64/35; B08B 7/02; B33Y 30/00; B33Y 40/20

(52) U.S. Cl. CPC B29C 64/35; B08B 7/02; B33Y 30/00; B33Y 40/20

(57) ABSTRACT

A three dimensional shaping device includes an ejection section that includes a nozzle and that is configured to eject a shaping material from the nozzle; a stage on which the shaping material is layered; a cleaning section that includes a cleaning member; a position changing section configured to change relative positions of the ejection section, the stage, and the cleaning section; and a control section, wherein the control section executes a cleaning operation of bringing the cleaning member and the nozzle into contact with each other by changing relative positions of the nozzle and the cleaning section and after the cleaning operation is executed, the control section executes at least one of a vibration operation of vibrating the cleaning member by moving the cleaning section and a vibration operation of vibrating the cleaning member by controlling a vibration section that vibrates the cleaning member.

The present application is based on, and claims priority from JP Application Serial Number 2023-198343, filed Nov. 22, 2023, the disclosure of which is hereby incorporated by reference herein in its entirety.

### BACKGROUND

### 1. Technical Field

The present disclosure relates to a three dimensional shaping device.

### 2. Related Art

JP-T-2010-530326 discloses a three dimensional shaping device including an end section cleaning assembly including a flicker plate and a brush. In the three dimensional shaping device, cleaning of an extrusion head is performed by bringing the extrusion head into contact with the flicker plate and the brush.

When a tip end of a nozzle provided in the three dimensional shaping device is cleaned using a cleaning member such as a flicker plate or a brush, there is a possibility that a waste material clinging to the cleaning member clings to the nozzle again, affecting the shaping accuracy.

### SUMMARY

According to a first aspect of the present disclosure, a three dimensional shaping device is provided.

The three dimensional shaping device includes an ejection section that includes a nozzle and that is configured to eject a shaping material from the nozzle; a stage on which the shaping material is layered; a cleaning section that includes a cleaning member; a position changing section configured to change relative positions of the ejection section, the stage, and the cleaning section; and a control section, wherein the control section executes a cleaning operation of bringing the cleaning member and the nozzle into contact with each other by changing relative positions of the nozzle and the cleaning section and after the cleaning operation is executed, the control section executes at least one of a vibration operation of vibrating the cleaning member by moving the cleaning section and a vibration operation of vibrating the cleaning member by controlling a vibration section that vibrates the cleaning member.

### BRIEF DESCRIPTION OF THE DRAWINGS

FIG. 1 is a description diagram showing a schematic configuration of a three dimensional shaping device in a first embodiment.

FIG. 2 is a description diagram showing a schematic configuration of the three dimensional shaping device in the first embodiment.

FIG. 3 is a perspective view showing a schematic configuration of a screw.

FIG. 4 is a schematic plan view of a barrel.

FIG. 5 is a perspective view of a cleaning mechanism.

FIG. 6 is a side view of the cleaning mechanism.

FIG. 7 is a perspective view of a cleaning section.

FIG. 8 is a perspective view of the cleaning section.

FIG. 9 is a description diagram showing a state in which a bottom surface of an accommodation section is in an open state.

FIG. 10 is a description diagram showing a state in which a waste material falls into a recovery section.

FIG. 11 is a flowchart of a cleaning process executed by a control section.

FIG. 12 is a flowchart of a cleaning process in a second embodiment.

FIG. 13 is a flowchart of a cleaning process in a third embodiment.

FIG. 14 is a perspective view showing a cleaning member in a fourth embodiment.

FIG. 15 is a front view of the cleaning member.

### DESCRIPTION OF EMBODIMENTS

### A. First Embodiment

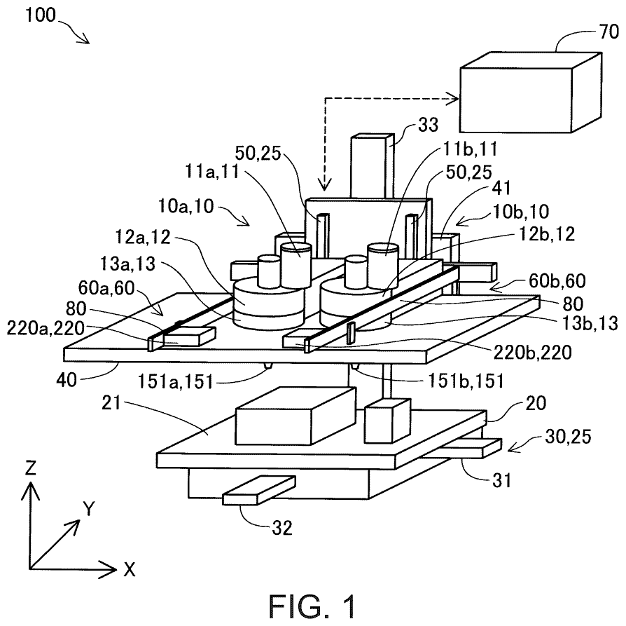

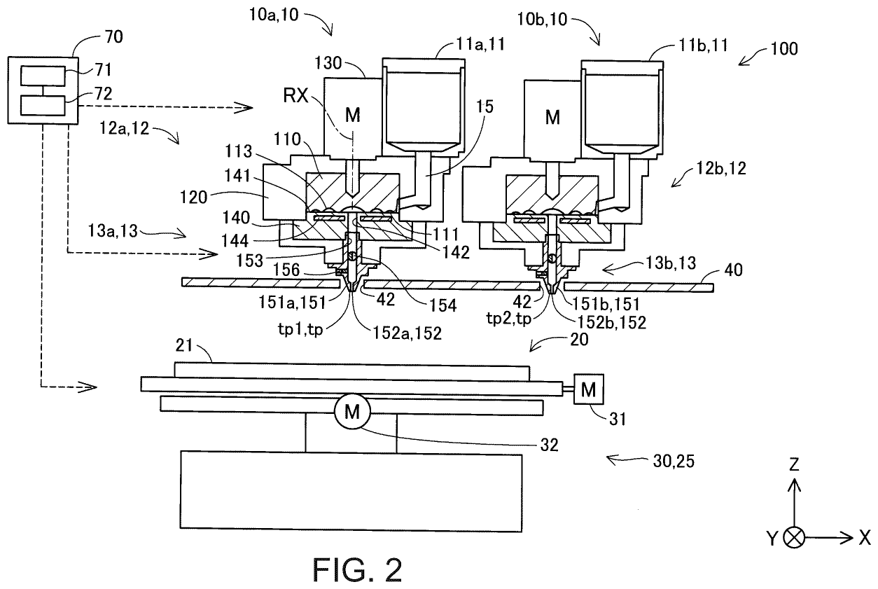

FIGS. 1 and 2 are description diagrams showing a schematic configuration of a three dimensional shaping device 100 in a first embodiment. FIGS. 1 and 2 show arrows indicating X, Y, and Z directions orthogonal to each other. The X direction and the Y direction are directions parallel to a horizontal plane, and the Z direction is a direction along a vertically upward direction. The arrows indicating the X, Y, and Z directions are appropriately shown in other drawings so that the directions shown in the drawings correspond to FIGS. 1 and 2. In the following description, when a direction is specified, a direction indicated by an arrow in each drawing is referred to as “+” and an opposite direction is referred to as “−”, and positive and negative signs are used in combination for direction notation. Hereinafter, a +Z direction is also referred to as “upper”, and a −Z direction is also referred to as “lower”.

The three dimensional shaping device 100 of the present embodiment is a device that shapes a shaped object by a material extrusion method. The three dimensional shaping device 100 includes heads 10 each including a nozzle 151, a stage 20, position changing sections 25, a heating section 40, head raising/lowering mechanisms 50, cleaning mechanisms 60 each including a cleaning section 220, and a control section 70. In FIG. 2, the head raising/lowering mechanisms 50 and the cleaning mechanisms 60 are omitted.

The control section 70 is a control device that controls operation of the entire three dimensional shaping device 100. As shown in FIG. 2, the control section 70 is composed of a computer including a CPU 71, a storage device 72, and an input/output interface for inputting and outputting signals to and from the outside. The control section 70 exhibits functions of executing a shaping process for shaping a three dimensional shaped object and functions of executing a cleaning process (to be described later) by the CPU 71 executing a program or a command read into a main storage device. In another embodiment, the control section 70 may be realized by a combination of a plurality of circuits for realizing at least a part of each function, instead of being constituted by a computer.

In a shaping process, the control section 70 shapes a three dimensional shaped object in accordance with shaping data for shaping the three dimensional shaped object. The shaping data includes, for each layer obtained by slicing a shape of a shaped object into a plurality of layers, path information indicating a movement path of the nozzle 151 and ejection amount information indicating the ejection amount of a plasticization material in each movement path.

The head 10 shown in FIGS. 1 and 2 ejects a shaping material for shaping a three dimensional shaped object onto a stage 20 serving as a base of the three dimensional shaped object under the control of the control section 70. In the present embodiment, a shaping material is a plasticization material obtained by plasticizing a material in a solid state into a paste state, as will be described later. The head 10 includes a material supply section 11, a plasticizing section 12, and an ejection section 13.

The three dimensional shaping device 100 includes a first head 10a and a second head 10b as the heads 10. The first head 10a includes a first material supply section 11a as the material supply section 11, a first plasticizing section 12a as the plasticizing section 12, and a first ejection section 13a as the ejection section 13. The second head 10b includes a second material supply section 11b as the material supply section 11, a second plasticizing section 12b as the plasticizing section 12, and a second ejection section 13b as the ejection section 13. The first head 10a and the second head 10b are arranged side by side in the X direction so that their positions in the Y direction coincide with each other. The second head 10b is arranged on a +X direction side of the first head 10a. Since the configuration of the first head 10a is the same as that of the second head 10b, the first head 10a and the second head 10b may be simply referred to as the head 10 in the following description unless they are distinguished from each other. In a case where the constituent members of both heads are distinguished from each other, the constituent members of the first head 10a are denoted by a reference symbol “a”, and the constituent members of the second head 10b are denoted by a reference symbol “b”.

The material supply section 11 supplies a material for generating a shaping material to the plasticizing section 12. The material supply section 11 is constituted by, for example, a hopper. The material supply section 11 accommodates a pellet-shaped or powder material. As the material, for example, a thermoplastic resin such as a polypropylene (PP) resin, a polyethylene (PE) resin, or a polyoxymethylene (POM) resin is used. The material accommodated in the first material supply section 11a and the material accommodated in the second material supply section 11b may be the same type of material or different types of materials.

A communication path 15 that connects the material supply section 11 and the plasticizing section 12 is provided below the material supply section 11. The material supply section 11 supplies the material to the plasticizing section 12 via the communication path 15.

The plasticizing section 12 plasticizes at least a part of the material supplied from the material supply section 11, generates a pasty shaping material having fluidity, and guides the shaping material to the ejection section 13. “Plasticization” is a concept including melting, and is a change from a solid to a state having fluidity. Specifically, in a case of a material in which glass transition occurs, plasticization means that the temperature of the material is set to be equal to or higher than the glass transition point. In a case of a material that does not undergo glass transition, plasticization refers to raising the temperature of the material above its melting point.

The plasticizing section 12 includes a screw 110, a screw case 120, a drive motor 130, and a barrel 140.

The screw 110 is housed in a screw case 120. An upper surface side of the screw 110 is connected to the drive motor 130. The screw 110 is rotated in the screw case 120 by rotational driving force generated by the drive motor 130. An axial direction of a screw rotation axis RX, which is a rotation axis of the screw 110, is the Z direction. The rotational speed of the screw 110 is controlled by the control section 70 controlling the rotational speed of the drive motor 130. The screw 110 may be driven by the drive motor 130 via a decelerator. The screw 110 is also referred to as a rotor or a flat screw.

The barrel 140 is arranged on a −Z direction side of the screw 110. A facing surface 141, which is an upper surface of the barrel 140, faces a groove forming surface 111, which is a lower surface of the screw 110. A communication hole 142 communicating with a flow path 153 of the ejection section 13 is formed in the center of the barrel 140. A plasticizing heater 144 is provided inside the barrel 140. The temperature of the plasticizing heater 144 is controlled by the control section 70.

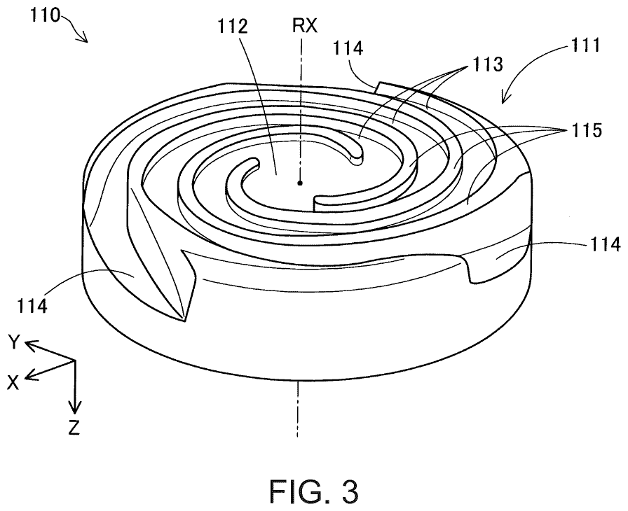

FIG. 3 is a perspective view showing a schematic configuration of the screw 110. The screw 110 has a substantially cylindrical shape whose length in a direction along the screw rotation axis RX is smaller than the length in a direction perpendicular to the screw rotation axis RX. On the groove forming surface 111, spiral grooves 113 are formed around a central section 112. The grooves 113 communicate with a material input port 114 formed in a side surface of the screw 110. The material supplied from the material supply section 11 is supplied to the grooves 113 through the material input port 114. The grooves 113 are formed by being separated from each other by ridge sections 115. FIG. 3 shows an example in which three grooves 113 are formed, but the number of grooves 113 may be one, two, or more. The grooves 113 are not limited to a spiral shape, but may be a helix or an involute curve shape, or may extend in an arc from the central section 112 to the outer periphery.

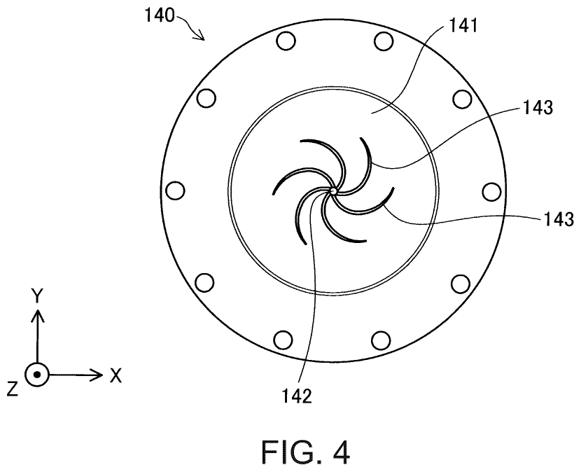

FIG. 4 is a schematic plan view of the barrel 140. A plurality of guide grooves 143 is formed around the communication hole 142 in the facing surface 141. Each guide groove 143 has one end connected to the communication hole 142 and extends in a spiral shape from the communication hole 142 toward the outer periphery of the facing surface 141. One end of the guide grooves 143 may not be connected to the communication hole 142. The guide grooves 143 may not be formed in the barrel 140.

The material supplied to the grooves 113 of the screw 110 flows along the grooves 113 while being plasticized in the grooves 113 by the rotation of the screw 110 and the heat of the plasticizing heater 144, and is guided to the central section 112 of the screw 110 as a shaping material. The pasty shaping material exhibiting fluidity that has flowed into the central section 112 is supplied to the ejection section 13 via the communication hole 142. The plasticizing section 12 may not plasticize all types of substances constituting the shaping material. The shaping material should be converted into a state having fluidity as a whole by plasticizing at least some kinds of substances that constitute the shaping material.

The ejection section 13 ejects the shaping material. The ejection section 13 includes the nozzle 151, the flow path 153, an ejection adjustment section 154, and a suction section 156.

The nozzle 151 is connected to the communication hole 142 of the barrel 140 through the flow path 153. The nozzle 151 ejects the shaping material generated in the plasticizing section 12 toward the stage 20 from a nozzle opening 152, which is an opening formed in a tip end section tp of the nozzle 151. Specifically, the first nozzle 151a ejects the shaping material from a first nozzle opening 152a formed in a first tip end section tp1. The second nozzle 151b ejects the shaping material from a second nozzle opening 152b formed in a second tip end section tp2.

The ejection adjustment section 154 is provided in the flow path 153, and adjusts the opening degree of the flow path 153. In the present embodiment, the ejection adjustment section 154 is constituted by a valve, and changes an opening area of the flow path 153 by rotating in the flow path 153. The ejection adjustment section 154 is driven by a drive section (not shown) under the control of the control section 70. The drive section that drives the ejection adjustment section 154 is constituted by, for example, a stepper motor. The control section 70 can adjust the flow amount of the shaping material flowing from the plasticizing section 12 to the nozzle 151, that is, the ejection amount of the shaping material ejected from the nozzle 151 by controlling the rotation angle of the valve. The ejection adjustment section 154 can adjust the ejection amount of the shaping material and can control ON/OFF of the outflow of the shaping material. The shape of the valve is not limited as long as it rotates in the flow path 153 to adjust the opening degree of the flow path 153, and may be, for example, a plate shape or a hemispherical shape. In another embodiment, the ejection adjustment section 154 may be configured as, for example, a piston mechanism that adjusts the opening degree of the flow path 153 by the operation of a piston, or a shutter mechanism that adjusts the opening degree of the flow path 153 by opening and closing a shutter.

The suction section 156 is connected between the ejection adjustment section 154 and the nozzle opening 152 in the flow path 153. The suction section 156 suppresses a tailing phenomenon in which a shaping material drips from the nozzle opening 152 in a thread-like manner, by temporarily sucking the shaping material in the flow path 153 at the time of stopping the ejection of the shaping material from the nozzle 151. The suction section 156 is constituted by a plunger. The suction section 156 is controlled by the control section 70. The suction section 156 is driven by a drive section (not shown) under the control of the control section 70. The drive section for driving the suction section 156 is constituted by, for example, a stepper motor, a rack and pinion mechanism for converting a rotational force of the stepper motor into a translational motion of the plunger, or the like.

The stage 20 is arranged at a position facing the nozzle opening 152 of the nozzle 151. The three dimensional shaping device 100 shapes a three dimensional shaped object by ejecting a shaping material from the nozzle 151 to a shaping surface 21, which is an upper surface of the stage 20, and layering shaped layers. The region on the shaping surface 21 in which the three dimensional shaped object is shaped is also referred to as a shaping region. A direction in which the shaping material is layered on the shaping surface 21 is also referred to as a layering direction.

The position changing section 25 changes the relative positions of the ejection section 13, the stage 20, and the cleaning section 220. As shown in FIG. 1, the position changing section 25 in the present embodiment includes a stage movement section 30 and the head raising/lowering mechanism 50.

The stage movement section 30 changes the relative positions of the ejection section 13 and the stage 20. The stage movement section 30 includes a first electric actuator 31 that moves the stage 20 along the X direction, a second electric actuator 32 that moves the stage 20 and the first electric actuator 31 along the Y direction, and a third electric actuator 33 that moves the head 10 along the Z direction. The third electric actuator 33 moves the first head 10a, the second head 10b, and the cleaning section 220 along the Z direction by moving a plate-shaped movable section 41 to which the first head 10a, the second head 10b, and the cleaning section 220 are fixed along the Z direction. The first electric actuator 31, the second electric actuator 32, and the third electric actuator 33 are driven under the control of the control section 70. In FIG. 2, the third electric actuator 33 and the movable section 41 are omitted.

In another embodiment, for example, the stage movement section 30 may move the stage 20 in the Z direction and move the first head 10a and the second head 10b along the X direction and the Y direction. The stage movement section 30 may move the stage 20 in the X direction, the Y direction, and the Z direction without moving the first head 10a and the second head 10b. The stage movement section 30 may move the first head 10a and the second head 10b in the X direction, the Y direction, and the Z direction without moving the stage 20.

The head raising/lowering mechanism 50 moves the head 10 in the Z direction with respect to the cleaning section 220. When the head 10 is moved by the head raising/lowering mechanism 50, the relative positions of the ejection section 13 and the stage 20 in the Z direction is also changed in addition to the relative positions of the ejection section 13 and the cleaning section 220 in the Z direction. The three dimensional shaping device 100 is provided with two head raising/lowering mechanisms 50 corresponding to the first head 10a and the second head 10b. In the present embodiment, one head raising/lowering mechanism 50 moves the first head 10a in the Z direction, and the other head raising/lowering mechanism 50 moves the second head 10b in the Z direction. Each head raising/lowering mechanism 50 is fixed to the movable section 41, and is moved in the Z direction by the third electric actuator 33 together with the head 10 and the cleaning mechanism 60. Each head raising/lowering mechanism 50 is configured as, for example, an electric actuator, and is individually driven under the control of the control section 70. In FIG. 2, the head raising/lowering mechanism 50 is omitted.

The heating section 40 heats the shaping material layered on the stage 20. The heating section 40 has a plate shape and includes a heater. Two arm sections 80 extending along the Y direction are fixed to the movable section 41, and the heating section 40 hangs from the two arm sections 80 to be supported so as to face the shaping surface 21. That is, the heating section 40 is fixed to the movable section 41 via the two arm sections 80. The heating section 40 is moved in the Z direction by the third electric actuator 33 together with the heads 10 fixed to the movable section 41. Therefore, the position of the heating section 40 relative to the stage 20 changes together with the first head 10a and the second head 10b.

As shown in FIG. 2, the heating section 40 is provided with openings 42 penetrating the heating section 40 in the Z direction. Specifically, the heating section 40 is provided with two openings 42 corresponding to the first nozzle 151a and the second nozzle 151b.

In the present embodiment, each of the first nozzle 151a and the second nozzle 151b is configured to be capable of switching between a shaping state and a retreated state by the head raising/lowering mechanism 50. The shaping state refers to a state in which the nozzle opening 152 is arranged between the heating section 40 and the stage 20 in the Z direction. In the shaping state, at least a portion of the nozzle 151 is arranged within the opening 42. The nozzle 151 is in a shaping state at least at the time of shaping. The time of shaping refers to the timing at which the shaping material is ejected to the shaping region in order to shape shaped layers. In FIGS. 1 and 2, the first nozzle 151a and the second nozzle 151b are in the shaping state. The retreated state refers to a state in which the nozzle opening 152 is arranged above the heating section 40. In the retreated state, the nozzle 151 is arranged outside the opening 42. The head raising/lowering mechanism 50 moves the head 10 in the +Z direction when switching the nozzle 151 from the shaping state to the retreated state, and moves the head 10 in the −Z direction when switching the nozzle 151 from the retreated state to the shaping state.

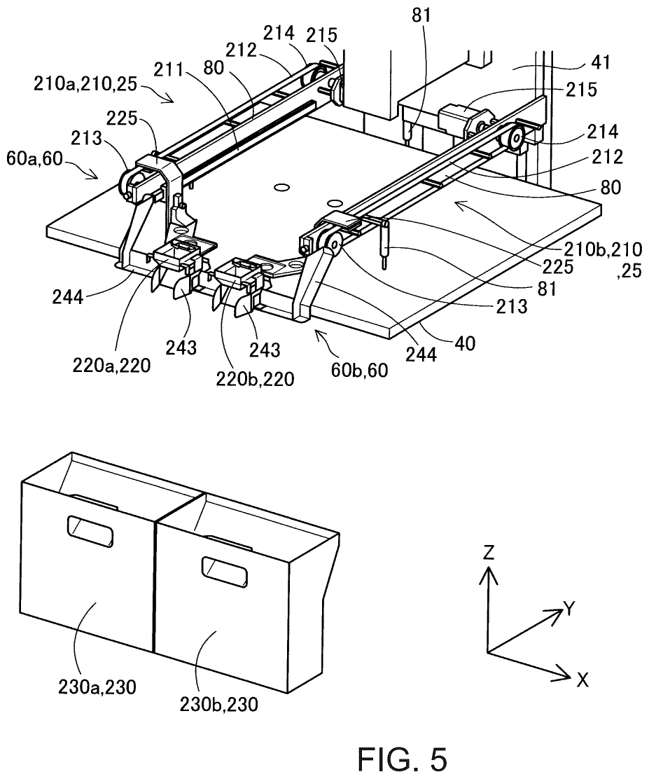

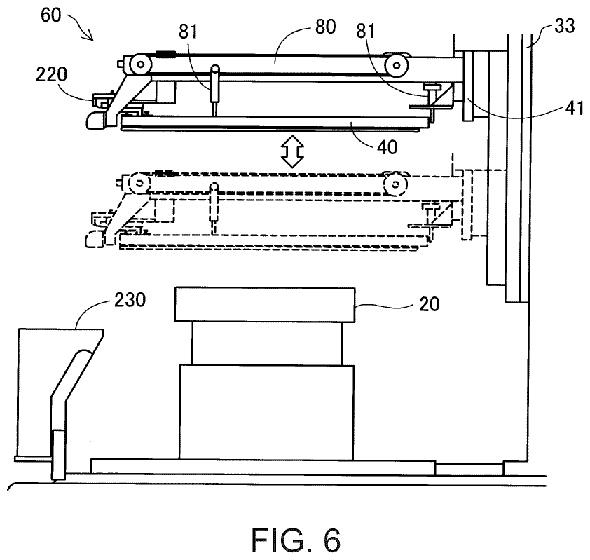

FIG. 5 is a perspective view of the cleaning mechanism 60. FIG. 6 is a side view of the cleaning mechanism 60. In the present embodiment, the cleaning mechanism 60 is attached to the arm section 80. The heating section 40 hangs from the arm section 80 by a hanging member 81. Therefore, as shown in FIG. 6, the cleaning mechanism 60 is moved in the Z direction together with the heating section 40 by the movable section 41 to which the arm section 80 is fixed being driven by the third electric actuator 33.

The cleaning mechanism 60 is a mechanism for cleaning the nozzle 151. As shown in FIG. 5, the cleaning mechanism 60 includes a cleaning movement section 210 and the cleaning section 220. In the present embodiment, the cleaning mechanism 60 includes a first cleaning mechanism 60a and a second cleaning mechanism 60b. The first cleaning mechanism 60a includes a first cleaning movement section 210a as the cleaning movement section 210 and a first cleaning section 220a as the cleaning section 220. The second cleaning mechanism 60b includes a second cleaning movement section 210b as the cleaning movement section 210 and a second cleaning section 220b as the cleaning section 220. The first cleaning mechanism 60a performs cleaning of the first nozzle 151a and the second cleaning mechanism 60b performs cleaning of the second nozzle 151b. Recovery sections 230 for collecting the waste material removed from the nozzle 151 by the cleaning mechanism 60 are arranged below the cleaning sections 220. The recovery sections 230 include the first recovery section 230a and the second recovery section 230b. The first recovery section 230a is arranged below the first cleaning section 220a, and the second recovery section 230b is arranged below the second cleaning section 220b. The configurations of the first cleaning mechanism 60a and the second cleaning mechanism 60b are the same. When the constituent members of the first cleaning mechanism 60a and the second cleaning mechanism 60b are distinguished from each other, the constituent members of the first cleaning mechanism 60a are denoted by a reference symbol “a”, and the constituent members of the second cleaning mechanism 60b are denoted by a reference symbol “b”.

The cleaning movement section 210 moves the cleaning section 220 relative to the nozzle 151. The cleaning movement section 210 is also a part of the position changing section 25. The cleaning movement section 210 is fixed to the arm section 80. The cleaning movement section 210 includes a drive belt 212, a first pulley 213, a second pulley 214, and a belt drive section 215. The first pulley 213 is provided at an end section of the arm section 80 on a −Y direction side. The second pulley 214 is provided at an end section of the arm section 80 on a +Y direction side. The drive belt 212 is wound between the first pulley 213 and the second pulley 214. The belt drive section 215 drives the drive belt 212 by rotationally driving the second pulley 214. The belt drive section 215 is constituted by a motor, for example, and is controlled by the control section 70.

The cleaning section 220 is connected to the drive belt 212 via a connection section 225. The connection section 225 is configured to be movable in the Y direction along a guide rail 211 attached to the arm section 80. Therefore, the cleaning section 220 moves along the guide rail 211 in the Y direction when the drive belt 212 is driven by the belt drive section 215. With this configuration, the cleaning section 220 is moved relative to nozzle 151 by the cleaning movement section 210.

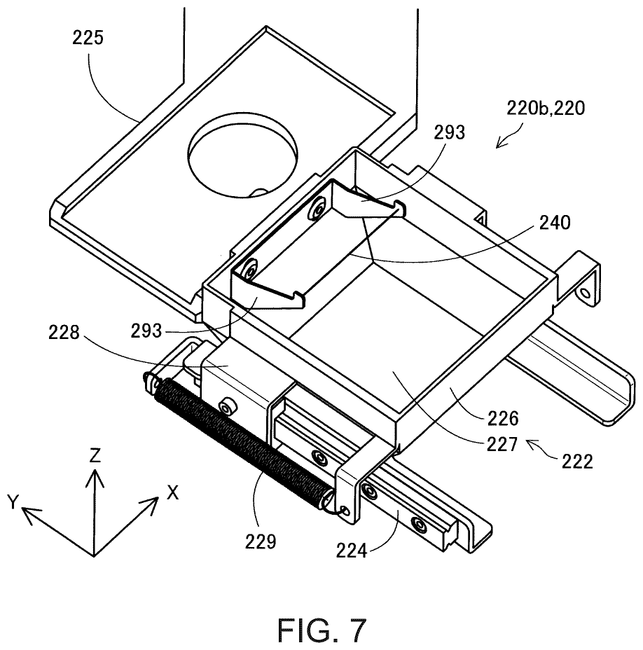

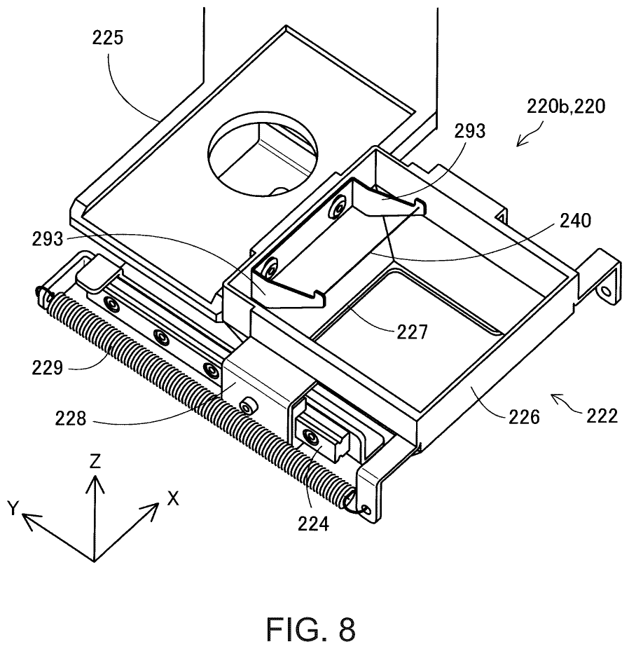

FIGS. 7 and 8 are perspective views of the cleaning section 220. FIGS. 7 and 8 show the second cleaning section 220b of the cleaning section 220. The second cleaning section 220b and the first cleaning section 220a have a symmetrical structure with respect to a Y-axis. The cleaning section 220 includes a cleaning member 240 and an accommodation section 222.

The cleaning member 240 is a member for cleaning the nozzle 151. The cleaning member 240 removes the waste material clinging to the nozzle 151 by contact between the cleaning member 240 and the nozzle 151. In the present embodiment, the cleaning member 240 is constituted by a wire made of stainless steel. The cleaning member 240 is stretched in the X direction by a pair of support sections 293. The wire constituting the cleaning member 240 may not be formed of stainless steel, and may be formed of, for example, steel, titanium, brass, or the like. The position of the cleaning member 240 in the Z direction is a position that can contact a tip end surface of the nozzle 151. For example, the cleaning member 240 is positioned on a +Z direction side of a tip end surface of the nozzle 151 by 0.1 mm to 0.5 mm.

The accommodation section 222 includes a cylindrical main body 226 and a bottom surface 227 arranged at a bottom section of the main body 226. The main body 226 is attached to the connection section 225. The cleaning member 240 is arranged above the accommodation section 222. The support sections 293 supporting the cleaning member 240 is fixed to an inner surface of the main body 226 in the +Y direction. The waste material removed from the nozzle 151 by the cleaning member 240 is accommodated in the accommodation section 222.

The bottom surface 227 of the accommodation section 222 is configured to be openable and closable. The main body 226 and the bottom surface 227 constituting the accommodation section 222 are relatively slidable in the Y direction. The bottom surface 227 is opened and closed when a slide member 228 connected to the main body 226 moves in the Y direction along a slide rail 224 connected to the bottom surface 227. A spring 229 is arranged between an end section of the main body 226 in the −Y direction and an end section of the bottom surface 227 in the +Y direction. The main body 226 and the bottom surface 227 are normally pulled toward each other by the spring 229, so that the bottom surface 227 is positioned at a bottom section of the main body 226 as shown in FIG. 7. By this, the bottom surface 227 is in a closed state. On the other hand, when the main body 226 and the bottom surface 227 are moved so as to be separated from each other, the spring 229 is pulled, the bottom surface 227 is moved in the +Y direction relative to the main body 226, and, as shown in FIG. 8, the bottom surface 227 enter a state of not existing on the bottom section of the main body 226. By this, the bottom surface 227 is in an open state.

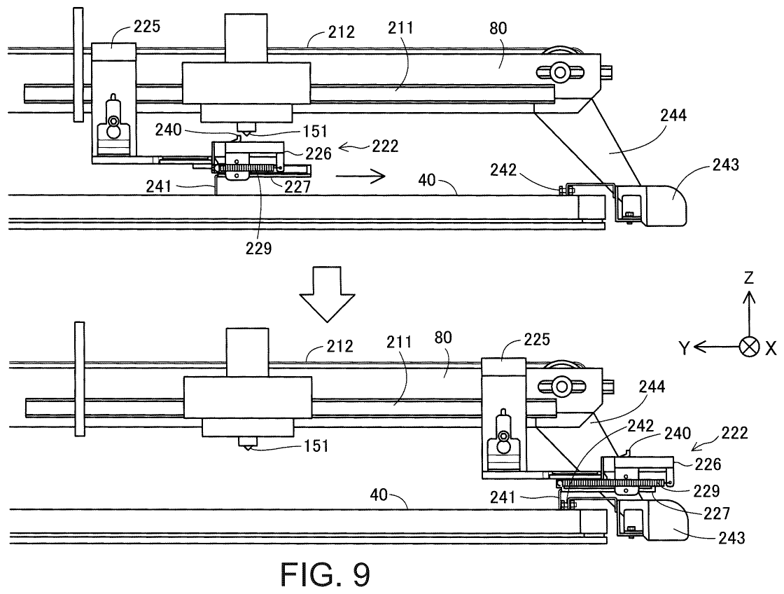

FIG. 9 is a description diagram showing a state in which the bottom surface 227 of the accommodation section 222 is in the open state. The control section 70 executes a movement operation of moving the cleaning section 220 in the horizontal direction from a position corresponding to the nozzle 151 toward a discharge position corresponding to the recovery section 230 by controlling the cleaning movement section 210. By this movement operation, the cleaning member 240 comes into contact with a tip end of the nozzle 151, and the waste material is removed from the nozzle 151. The upper part of FIG. 9 shows a state in which the cleaning section 220 is positioned at a position corresponding to the nozzle 151, and the lower part of FIG. 9 shows a state in which the cleaning section 220 is positioned at the discharge position corresponding to the recovery section 230.

When the accommodation section 222 moves toward the discharge position, a collision member 241 connected to the bottom surface 227 collides with a fixed member 242 connected to the arm section 80. By this collision, vibration is applied to the cleaning member 240, and in a case where the waste material clings on the cleaning member 240, the waste material falls from the cleaning member 240 into the accommodation section 222. Even after the collision member 241 connected to the bottom surface 227 collides with the fixed member 242 connected to the arm section 80, when the cleaning movement section 210 moves the cleaning section 220 in the −Y direction, the collision member 241 interferes with the fixed member 242, so that the bottom surface 227 provided with the collision member 241 stops at that position, and only the main body 226 of the accommodation section 222 slides toward the discharge position while pulling the spring 229. As described above, when the main body 226 slides with respect to the bottom surface 227, the bottom surface 227 enters the open state, and at the discharge position, the waste material falls from the accommodation section 222 toward the recovery section 230.

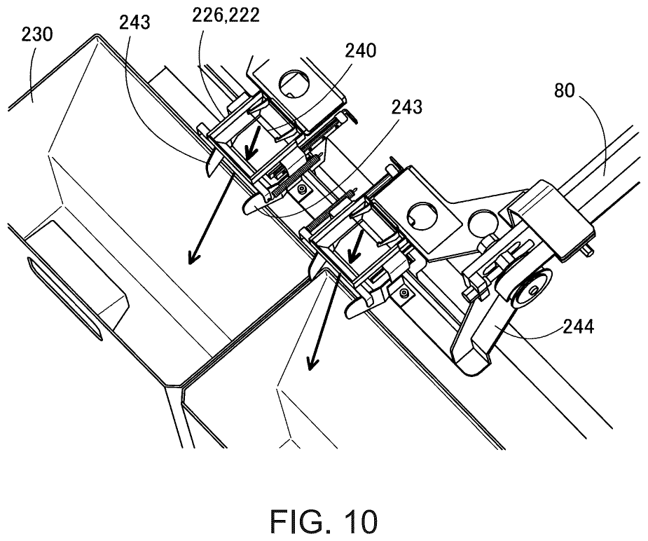

FIG. 10 is a description diagram showing a state in which waste material falls into the recovery section 230. As shown in FIGS. 5, 9, and 10, a guide section 243 for directing a falling direction of the waste material to the recovery section 230 is provided below the accommodation section 222 at the discharge position. The guide section 243 is fixed to the arm section 80 via a guide support section 244. The waste material slides down the guide section 243 and falls into the recovery section 230. In the present embodiment, two guide sections 243 are fixed to the arm section 80 so as to correspond to the first cleaning section 220a and the second cleaning section 220b. Therefore, the waste material collected by the first cleaning section 220a can be appropriately discharged to the first recovery section 230a, and the waste material collected by the second cleaning section 220b can be appropriately discharged to the second recovery section 230b. Therefore, in a case where different shaping materials are discharged from the first head 10a and the second head 10b, it is possible to appropriately collect the waste material for each shaping material, and thus it is easy to reuse the shaping material. Only one recovery section 230 may be provided.

The fixed member 242 shown in FIG. 9 is attached to the guide section 243 supported by the arm section 80. That is, the guide section 243 and the fixed member 242 are not fixed to the heating section 40, but are fixed to the movable section 41 via the arm section 80. Therefore, vibration generated when the collision member 241 provided on the bottom surface 227 of the accommodation section 222 collides with the fixed member 242 attached to the guide section 243 does not directly reach the heating section 40. By this, it is possible to suppress the reduction in parallelism of the heating section 40 with respect to the shaping surface 21 due to vibration.

In the present embodiment, the fixed member 242 is constituted by a bolt. Therefore, a collision position between the fixed member 242 and the collision member 241 can be adjusted by adjusting an attachment position of the fixed member 242 with respect to the guide section 243 in accordance with the degree of tightening of the bolt. By this, it is possible to finely adjust a position at which the cleaning section 220 drops the waste material.

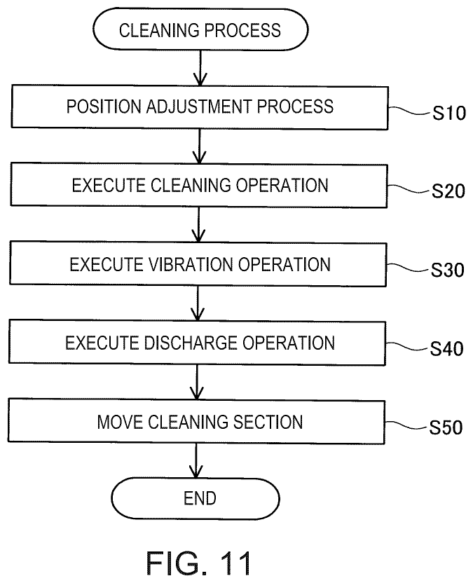

FIG. 11 is a flowchart of a cleaning process executed by the control section 70. This cleaning process is executed at a predetermined timing during the shaping of the three dimensional shaped object. The timing at which the cleaning process is executed may be determined based on, for example, the elapsed time during the shaping, the number of shaped layers, or the amount of the shaping material ejected from the nozzle 151. The timing at which the cleaning process is executed may be determined for each nozzle 151.

In step S10, the control section 70 executes a position adjustment process for adjusting the height of the nozzle 151 to be cleaned and an initial position of the cleaning section 220. In the following description of the cleaning process, the nozzle 151 refers to the “nozzle 151 to be cleaned” unless otherwise specified. In the position adjustment process, the control section 70 controls the head raising/lowering mechanism 50 to bring the nozzle 151 into the retreated state. In the retreated state of the nozzle 151, the control section 70 adjusts the height of the nozzle 151 to a position where the cleaning member 240 can contact a tip end of the nozzle 151. The control section 70 controls the cleaning movement section 210 so that the nozzle 151 is set in the retreated state and the cleaning member 240 provided in the cleaning section 220 is positioned in the +Y direction from a tip end of the nozzle 151.

In step S20, the control section 70 executes a cleaning operation. The cleaning operation is an operation in which the cleaning member 240 and the nozzle 151 are brought into contact with each other by changing the relative positions of the nozzle 151 and the cleaning section 220, thereby removing the waste material clinging to the nozzle 151. In the present embodiment, in this cleaning operation, the control section 70 controls the cleaning movement section 210 to move the cleaning section 220 in the −Y direction so that the cleaning member 240 moves while being in contact with a tip end of the nozzle 151. In this way, the waste material clinging to a tip end of the nozzle 151 is removed by the cleaning member 240. In the present embodiment, the control section 70 brings the cleaning member 240 into contact with the nozzle 151 once. On the other hand, the control section 70 may reciprocate the cleaning section 220 along the Y direction so that the cleaning member 240 comes into contact with a tip end of the nozzle 151 a plurality of times.

In step S30, the control section 70 executes a vibration operation. In the present embodiment, the vibration operation is an operation of applying vibration to the cleaning member 240. Specifically, the control section 70 controls the cleaning movement section 210 to move the cleaning section 220 in the −Y direction, and causes the collision member 241 provided on the cleaning section 220 to collide with the fixed member 242 fixed to the arm section 80, thereby applying vibration to the cleaning member 240. By applying vibration to the cleaning member 240 in this manner, when waste material clings to the cleaning member 240, the waste material can be dropped into the accommodation section 222 provided in the cleaning section 220. In the present embodiment, the control section 70 causes the cleaning section 220 to collide with the fixed member 242 three times by reciprocating the cleaning section 220 in the Y direction. The number of collisions is not limited to three, but may be one or two, or four or more. The number of collisions may be changed according to the type of the shaping material.

In step S40, the control section 70 executes a discharge operation. The discharge operation is an operation of moving the accommodation section 222 from a position where the fixed member 242 is arranged toward a discharge position where the waste material is discharged to the recovery section 230 after the vibration operation, and discharging the waste material to the recovery section 230. In the above-described vibration operation of step S30, the collision member 241 connected to the bottom surface 227 of the cleaning section 220 collides with the fixed member 242, so that the movement of the bottom surface 227 of the cleaning section 220 is stopped. After the movement of the bottom surface 227 is stopped, then in step S40, the control section 70 brings the bottom section of the main body 226 to the open state by sliding the main body 226 in the −Y direction. Thus, when the bottom section of the main body 226 is in the open state, the waste material falls from the accommodation section 222, and the waste material is discharged to the recovery section 230 while being guided by the guide section 243.

In step S50, the control section 70 controls the cleaning movement section 210 to return the cleaning section 220 from the discharge position to the initial position, and ends the above-described series of cleaning processes.

The three dimensional shaping device 100 of the present embodiment described above executes the cleaning operation by changing the relative positions of the nozzle 151 and the cleaning section 220 to bring the cleaning member 240 into contact with the nozzle 151, and after the cleaning operation, executes the vibration operation by moving the cleaning section 220 to apply vibration to the cleaning member 240. This vibration causes the waste material clinging to the cleaning member 240 to fall from the cleaning member 240. As a result, it is possible to prevent the waste material clinging to the cleaning member 240 from clinging to the nozzle 151 again, thereby preventing a decrease in the shaping accuracy of the three dimensional shaped object due to the cleaning of the nozzle 151.

In the present embodiment, the cleaning section 220 is moved and caused to collide with the fixed member 242, thereby applying vibration to the cleaning member 240. Therefore, the cleaning member 240 can be easily vibrated. In particular, in the present embodiment, since the cleaning section 220 is caused to collide with the fixed member 242 a plurality of times, it is possible to increase the possibility that the waste material falls from the cleaning member 240.

In the present embodiment, the cleaning section 220 includes the accommodation section 222 in which the waste material removed from the nozzle 151 is accommodated, and the accommodation section 222 includes the cylindrical main body 226 and the bottom surface 227 arranged on the bottom section of the main body 226, and the main body 226 and the bottom surface 227 are configured to be relatively slidable. In the present embodiment, in the vibration operation, the movement of the bottom surface 227 is stopped by causing the collision member 241 connected to the bottom surface 227 to collide with the fixed member 242, and after the movement of the bottom surface 227 is stopped, the bottom section of the main body 226 is brought into the open state by sliding the main body 226 with respect to the bottom surface 227. Therefore, application of vibration to the cleaning member 240 and discharge of the waste material from the cleaning section 220 can be continuously performed only by moving the cleaning section 220, and the cleaning process can be efficiently executed.

### B. Second Embodiment

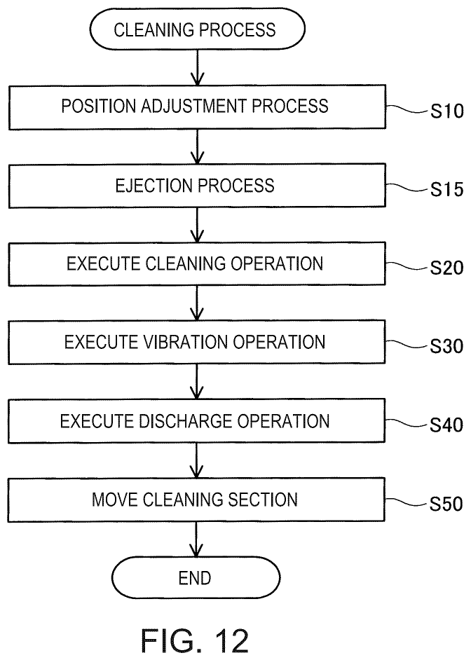

FIG. 12 is a flowchart of a cleaning process in a second embodiment. The configuration of the three dimensional shaping device 100 in the second embodiment is the same as that in the first embodiment.

In the cleaning process of the second embodiment, the process of step S15 is added to the cleaning process of the first embodiment shown in FIG. 11. Specifically, after the position adjustment process is performed in step S10, an ejection process is performed in step S15.

In the ejection process, the control section 70 ejects the shaping material from the nozzle 151 such that a predetermined amount of the shaping material hangs down from the nozzle 151. Then, in step S20, the control section 70 executes the cleaning operation to bring the cleaning member 240 and the nozzle 151 into contact with each other and remove the shaping material in a state of hanging down from the nozzle 151 as waste material. Since the processes after step S30 is the same as that in the first embodiment, the description thereof is omitted.

In the above-described step S15, the control section 70 ejects a predetermined amount of the shaping material according to the type of the shaping material. For example, in a case where the diameter of the nozzle opening 152 is 0.4 mm and the shaping material is ABS resin, the shaping material of the length 60 mm is ejected from the nozzle 151. The length of the shaping material to be ejected is made longer as the diameter of the nozzle opening 152 is smaller.

It is desirable that the amount of the shaping material ejected in step S15 satisfies the conditions that the adhesion force of the shaping material to the cleaning member 240 is larger than the self-weight of the shaping material, and the adhesion force of the shaping material to the cleaning member 240 is smaller than the value obtained by adding the inertial force due to vibration to the self-weight of the shaping material. According to the conditions, it is possible to determine the minimum amount of the shaping material at which the shaping material can be dropped from the cleaning member 240 by the vibration operation of step S30. Therefore, it is possible to save the amount of the shaping material used in the cleaning process. The inertial force due to vibration can be adjusted by changing the speed at which the cleaning section 220 is caused to collide with the fixed member 242.

The amount of the shaping material corresponding to the type of the shaping material is determined, for example, by specifying the amount satisfying the above-described conditions for each shaping material by an experiment or simulation, and is stored in the storage device 72. The control section 70 specifies the amount of the shaping material to be ejected from the nozzle 151 in step S15 by referring to the relationship between the type of the shaping material and the amount of the shaping material stored in the storage device 72.

According to the description of the second embodiment, since the cleaning operation and the vibration operation are performed in a state where the shaping material of an amount determined according to the type of the shaping material is ejected from the nozzle 151, it is possible to easily remove the shaping material as a waste material from the nozzle 151.

### C. Third Embodiment

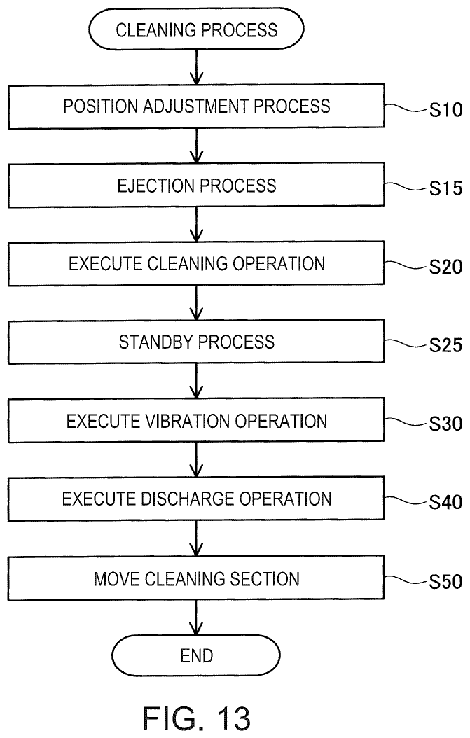

FIG. 13 is a flowchart of a cleaning process in a third embodiment. The configuration of the three dimensional shaping device 100 in the third embodiment is the same as that in the first embodiment.

In the cleaning process of the third embodiment, the process of step S25 is added to the cleaning process of the second embodiment shown in FIG. 12. Specifically, after the ejection process described in the second embodiment is executed in step S15 and the cleaning operation is executed in step S20, a standby process is executed in step S25 before the vibration operation is executed in step S30. The processing contents after step S30 are the same as those in the first embodiment.

In the standby process of step S25, the control section 70 causes the cleaning section 220 to stand by between the nozzle 151 and the fixed member 242 for a period of time determined according to the type of the shaping material, and then shifts the processing to the vibration operation of step S30. The standby time in step S25 is a time required for the shaping material clinging to the cleaning member 240 to cool sufficiently. As for the standby time, a longer time is set for a shaping material with a larger heat capacity. For example, PP is set to 20 seconds and POM is set to 15 seconds. Since ABS has a small heat capacity and cools easily, the standby time can be set to zero seconds, for example. It is desirable to set the standby time so that the shaping material is cooled to a temperature lower than the glass transition point when the shaping material is an amorphous resin, and to a temperature lower than the melting point when the shaping material is a crystalline resin.

According to the third embodiment described above, after the shaping material is removed by the cleaning member 240, the standby process of performing standby for a time corresponding to the shaping material is executed, so that it is possible to cool and cure the shaping material clinging to the cleaning member 240. Thus, in the vibration operation, the shaping material as a waste material can be reliably dropped from the cleaning member 240, and the waste material can be suppressed from clinging to the nozzle 151 again.

The three dimensional shaping device 100 may include a cooling device for cooling the shaping material clinging to the cleaning member 240 during the standby period. Thus, the standby time can be shortened, and the cleaning process can be performed efficiently.

### D. Fourth Embodiment

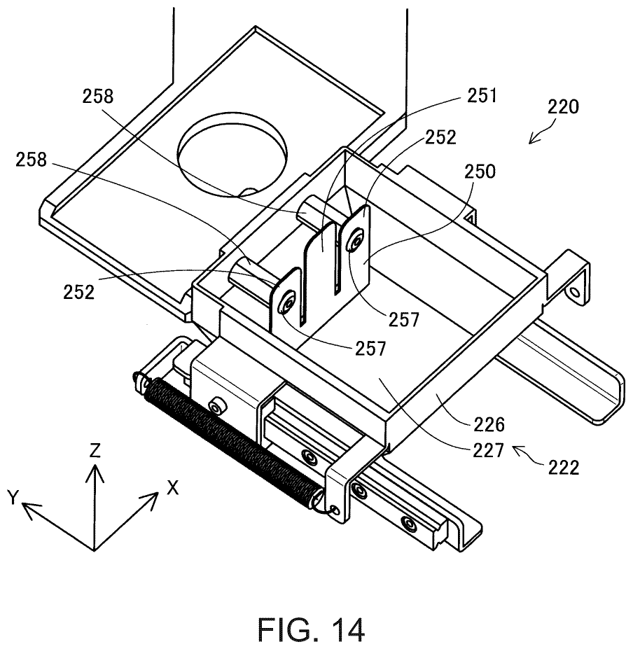

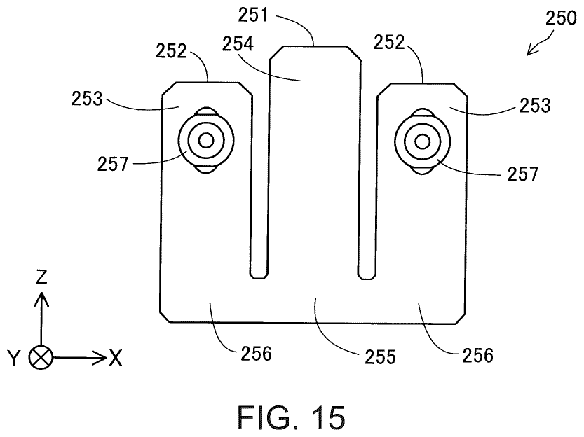

FIG. 14 is a perspective view showing a cleaning member 250 according to a fourth embodiment. FIG. 15 is a front view of the cleaning member 250. In the fourth embodiment, only the shape of the cleaning member 250 is different from that of the first embodiment, and the other configurations of the three dimensional shaping device 100 are the same as those of the first embodiment.

The cleaning member 250 in the fourth embodiment is a plate-shaped body. The cleaning member 250 is formed of a metal plate such as SUS, for example. The hardness of the cleaning member 250 is smaller than the hardness of the nozzle 151. The cleaning member 250 includes a tongue section 251 extending upward in a direction toward the nozzle 151, and fixing sections 252 for fixing the tongue section 251 to the cleaning section 220. In the fourth embodiment, the cleaning member 250 is provided with two fixing sections 252. One fixing section 252 may be provided. The height of the tongue section 251 is higher than the height of the fixing section 252. In addition, the length of the tongue section 251 along the Z direction is longer than the length of the fixed member 242. In the above-described cleaning operation, an upper end of the tongue section 251 comes into contact with a tip end of the nozzle 151, and the nozzle 151 is cleaned. The tongue section 251 may be referred to as a first member, and the fixing section 252 may be referred to as a second member.

An upper end section 253 of the fixing section 252 is arranged at a distance from an upper end section 254 of the tongue section 251 in the X direction intersecting the Z direction. Abase end section 255 of the tongue section 251, which is in a direction opposite from the upper end section 254, and a base end section 256 of the fixing section 252, which is in a direction opposite from the upper end section 253, are integrally connected. The upper end section 253 of the fixing section 252 is fixed to a spacer member 258 by a screw 257. The spacer member 258 extends in the −Y direction from an inner surface of the main body 226 of the accommodation section 222 in the +Y direction.

According to the fourth embodiment described above, since the nozzle 151 can be cleaned by the plate-shaped cleaning member 250, the shear stress applied to the waste material increases. Therefore, shaping material having high hardness can also be removed.

Since the cleaning member 250 of the fourth embodiment is plate-shaped, the shaping material is easily peeled off when vibration is applied during the cleaning process.

Since the cleaning member 250 has a plate shape and includes a tongue section 251 and fixing sections 252, the surface area is increased. Therefore, the waste material clinging to the cleaning member 250 easily cools, and the shaping material easily drops when vibration is applied during the cleaning process.

The cleaning member 250 has a shape in which the tongue section 251 and the fixing sections 252 are arranged in a horizontal direction. Therefore, since the length in the Z direction can be shortened, the installation space of the cleaning member 250 can be reduced.

### E. Other Embodiments

(E1) In the above-described embodiment, the control section 70 controls the cleaning movement section 210 to cause the cleaning section 220 to collide with the fixed member 242, thereby applying vibration to the cleaning members 240 and 250. On the other hand, for example, the control section 70 may control the cleaning movement section 210 to reciprocate the cleaning section 220 in a very small range, thereby applying vibration to the cleaning members 240 and 250. For example, the three dimensional shaping device 100 may include a vibration section, and the control section 70 may control the vibration section to apply vibration to the cleaning member 240. The vibration section can be provided in the cleaning section 220, for example. The vibration section is constituted by, for example, an electric motor in which an unbalanced weight is attached to the rotation axis.

(E2) In the above-described embodiment, the three dimensional shaping device 100 may be provided with a cooling device for cooling the cleaning members 240 and 250. The control section 70 cools the cleaning members 240 and 250 before the cleaning operation using the cooling device, and thus in the cleaning operation it is easy to remove from the nozzle 151, the shaping material softened by the heat transfer from the nozzle 151.

(E3) The cleaning process in the above embodiment, in addition to being executed during the shaping of the three dimensional shaped object, or instead of being executed during the shaping of the three dimensional shaped object, may be executed before the discharge of the first shaping material for shaping the three dimensional shaped object is started, or may be executed after the completion of the shaping of the three dimensional shaped object. The cleaning process may be executed when a predetermined start operation is performed on the control section 70 by a user. For example, different cleaning processes may be executed between a cleaning process executed during the shaping of the three dimensional shaped object and a cleaning process executed other than during the shaping.

(E4) In each of the above-described embodiments, the three dimensional shaping device 100 includes two heads 10. On the other hand, the three dimensional shaping device 100 may include only one head 10 or three or more heads 10.

### F. Other Configurations

The present disclosure is not limited to the above-described embodiments, and can be realized in various configurations without departing from the spirit thereof. For example, the technical features of the embodiments corresponding to the technical features in each aspect described below can be appropriately replaced or combined in order to solve a part or all of the problems described above or to achieve a part or all of the effects described above. Unless the technical features are described as essential in the present specification, they can be appropriately deleted.

(1) According to a first aspect of the present disclosure, a three dimensional shaping device is provided.

The three dimensional shaping device includes an ejection section that includes a nozzle and that is configured to eject a shaping material from the nozzle; a stage on which the shaping material is layered; a cleaning section that includes a cleaning member; a position changing section configured to change relative positions of the ejection section, the stage, and the cleaning section; and a control section, wherein the control section executes a cleaning operation of bringing the cleaning member and the nozzle into contact with each other by changing relative positions of the nozzle and the cleaning section and after the cleaning operation is executed, the control section executes at least one of a vibration operation of vibrating the cleaning member by moving the cleaning section and a vibration operation of vibrating the cleaning member by controlling a vibration section that vibrates the cleaning member.

According to such an aspect, it is possible to prevent waste material clinging to the cleaning member from re-clinging to the nozzle, thereby preventing a decrease in the shaping accuracy of the three dimensional shaped object due to the cleaning of the nozzle.

(2) The three dimensional shaping device according to the above-described aspect may be configured such that the control section applies vibration to the cleaning member by causing the cleaning section to move and collide with a fixed member.

According to such an aspect, the cleaning member can be easily vibrated.

(3) The three dimensional shaping device according to the above-described aspect may be configured such that the cleaning section includes an accommodation section in which waste material removed from the nozzle is accommodated, the accommodation section includes a main body and a bottom surface arranged at a bottom section of the main body, and the main body and the bottom surface are configured to slide relative to each other, after the vibration operation, the control section executes a discharge operation of discharging the waste material to a recovery section by moving the accommodation section from a position at which the fixed member is arranged toward a position at which the waste material is discharged to the recovery section, the control section executes the vibration operation by causing a collision member connected to the bottom surface to collide with the fixed member, and in the discharge operation, the control section stops movement of the bottom surface by causing the collision member to collide with the fixed member, and then slides the main body with respect to the bottom surface to bring the bottom section of the main body into an open state.

According to such an aspect, application of vibration to the cleaning member and discharge of the waste material from the cleaning section can be performed continuously only by moving the cleaning section.

(4) The three dimensional shaping device according to the above-described aspect may be configured such that the control section causes the cleaning section to collide with the fixed member a plurality of times.

According to such an aspect, the possibility that the waste material falls from the cleaning member can be increased.

(5) The three dimensional shaping device according to the above-described aspect may be configured such that in the cleaning operation, the control section causes the cleaning member and the nozzle to come into contact with each other in a state in which an amount of the shaping material determined according to type of the shaping material is ejected from the nozzle and the shaping material hangs down from the nozzle.

According to such an aspect, the shaping material as a waste material can be easily removed from the nozzle.

(6) The three dimensional shaping device according to the above-described aspect may be configured such that the control section executes the vibration operation after execution of the cleaning operation and after standing by for a time period determined according to type of the shaping material.

According to such an aspect, it is possible to cool and cure the shaping material as the waste material clinging to the cleaning member. Therefore, in the vibration operation, it is possible to increase the reliability of dropping the shaping material from the cleaning member.

(7) The three dimensional shaping device according to the above-described aspect may be configured such that the cleaning member is a plate-shaped body, the cleaning member includes a tongue section extending in a direction toward the nozzle, and a fixing section for fixing the tongue section to the cleaning section, and an end section of the tongue section in the direction and an end section of the fixing section in the direction are arranged at a distance from each other in a direction intersecting with the direction, and an end section of the tongue section in a direction that is opposite to the direction and an end section of the fixing section in a direction that is opposite to the direction are integrally connected.

According to such an aspect, since the cleaning member is a plate-shaped body, the shaping material is easily peeled off when vibration is applied.

The present disclosure is not limited to the aspect of the three dimensional shaping device described above and can be realized by various aspects such as a method of cleaning a nozzle and a method of manufacturing a three dimensional shaped object.

What is claimed is:

1. A three dimensional shaping device comprising:
an ejection section that includes a nozzle and that is configured to eject a shaping material from the nozzle;
a stage on which the shaping material is layered;
a cleaning section that includes a cleaning member;
a position changing section configured to change relative positions of the ejection section, the stage, and the cleaning section; and
a control section, wherein
the control section executes a cleaning operation of bringing the cleaning member and the nozzle into contact with each other by changing relative positions of the nozzle and the cleaning section and
after the cleaning operation is executed, the control section executes at least one of a vibration operation of vibrating the cleaning member by moving the cleaning section and a vibration operation of vibrating the cleaning member by controlling a vibration section that vibrates the cleaning member.

2. The three dimensional shaping device according to claim 1, wherein
the control section applies vibration to the cleaning member by causing the cleaning section to move and collide with a fixed member.

3. The three dimensional shaping device according to claim 2, wherein
the cleaning section includes an accommodation section in which waste material removed from the nozzle is accommodated,
the accommodation section includes a main body and a bottom surface arranged at a bottom section of the main body, and the main body and the bottom surface are configured to slide relative to each other,
after the vibration operation, the control section executes a discharge operation of discharging the waste material to a recovery section by moving the accommodation section from a position at which the fixed member is arranged toward a position at which the waste material is discharged to the recovery section,
the control section executes the vibration operation by causing a collision member connected to the bottom surface to collide with the fixed member, and
in the discharge operation, the control section stops movement of the bottom surface by causing the collision member to collide with the fixed member, and then slides the main body with respect to the bottom surface to bring the bottom section of the main body into an open state.

4. The three dimensional shaping device according to claim 2, wherein
the control section causes the cleaning section to collide with the fixed member a plurality of times.

5. The three dimensional shaping device according to claim 1, wherein
in the cleaning operation, the control section causes the cleaning member and the nozzle to come into contact with each other in a state in which an amount of the shaping material determined according to type of the shaping material is ejected from the nozzle and the shaping material hangs down from the nozzle.

6. The three dimensional shaping device according to claim 1, wherein
the control section executes the vibration operation after execution of the cleaning operation and after standing by for a time period determined according to type of the shaping material.

7. The three dimensional shaping device according to claim 1, wherein
the cleaning member is a plate-shaped body,
the cleaning member includes a tongue section extending in a direction toward the nozzle, and a fixing section for fixing the tongue section to the cleaning section, and
an end section of the tongue section in the direction and an end section of the fixing section in the direction are arranged at a distance from each other in a direction intersecting with the direction, and an end section of the tongue section in a direction that is opposite to the direction and an end section of the fixing section in a direction that is opposite to the direction are integrally connected.
